(19) United States
(12) Patent Application Publication
(10) Pub. No.: US 2012/0266669 A1
(43) Pub. Date: Oct. 25, 2012

(54) Sensor Arrangement

(75) Inventor: Ian Charles Sage, Worcestershire (GB)

(73) Assignee: QINETIQ LIMITED, Farnborough Hampshire (UK)

(21) Appl. No.: 13/511,406

(22) PCT Filed: Nov. 23, 2010
(86) PCT No.: PCT/GB10/02152

§ 371 Date: May 23, 2012

(30) Foreign Application Priority Data
Nov. 24, 2009 (GB) 0920512.1

(51) Int. Cl. G01N 25/00

(52) U.S. Cl. 73/170.26

(57) ABSTRACT

The present invention relates to an improved sensor arrangement, a system and method for determining the rate of ice formation and how close conditions are to those at which ice will form on a surface, and to an improved sensor arrangement for use therein. The sensor arrangement comprises a means (11,12,14) for measuring the thermal lag, heating and cooling of a thermally conductive element, which is comprised of a first and second surface (15a, 15b), said first surface exposed to the environment, wherein the surface area of said first surface is smaller than the second surface. The step of ice detection may be performed by either a passive measuring system wherein the latent heat of ice formation is measured via the temperature differential across a Peltier element. In an alternative arrangement the detector may preferably be an active system comprising heating or cooling the Peltier device and, whilst such heating or cooling is being conducted, also measuring the temperature of the exposed outer first surface using a separate temperature detector.

The present invention relates to a system and method for determining the rate of ice formation and how close conditions are to those at which ice will form on a surface, and to an improved sensor arrangement for use therein.

On aircraft, ice build-up on the wings, propellers, rotor blades, control surfaces etc. can cause the pilot difficulties by adversely affecting aircraft control. Whether or not ice will form depends on the local environmental conditions, such as atmospheric temperature, pressure and moisture content, as well as the speed of the aircraft. Conventionally, ice detectors are employed, which typically look for the presence of ice on an exterior surface of the aircraft so as to generate an indication or warning of the existence of icing conditions. It is a disadvantage that these devices can only detect icing conditions once ice has started to form. They cannot determine how close the conditions are to icing, or whether, or how fast conditions are changing. To ensure the aircraft remains controllable and safe, it is important for the pilot to know what the current air conditions are, how close they are to icing conditions, and whether ice is likely to form on the aircraft surfaces if no averting action is taken.

According to a first aspect of the present invention there is provided a sensor device for use in a system for determining the rate of ice formation of an environment the device comprising:

a thermally conductive element comprising a first and second surface, said first surface exposed to the environment;
means, connectable to a power source, for cooling or heating the second surface;
and a temperature detector for providing a signal representative of the temperature of the first surface;
whereby the rate of ice formation can be determined from the temperature signals and power required to heat or cool the second surface of said thermally conductive element to a temperature indicative of ice formation on said first surface, characterised in that the surface area of said first surface is smaller than the second surface.

The sensor may be used for ice detection, both to measure the actual rate of ice formation during icing conditions and/or to measure the likelihood i.e. the proximate nature of icing conditions in typical ice forming environments where ice formation is a hazard.

The step of ice detection may be performed by either a passive measuring system wherein the latent heat of ice formation is measured via the temperature differential across a Peltier element. In an alternative arrangement the detector may preferably be an active system comprising heating or cooling the Peltier device and, whilst such heating or cooling is being conducted, also measuring the temperature of the exposed outer first surface using a separate temperature detector.

According to a second aspect of the present invention there is provided a sensor device for use in a system for determining a proximity to icing conditions of an environment the device comprising:

a thermally conductive element comprising a first and second surface, said first surface exposed to the environment;
means, connectable to a power source, for cooling or heating the second surface; and
a temperature detector for providing a signal representative of the temperature of the first surface;
whereby the proximity to icing conditions of the environment can be determined from the temperature signals and power required to heat or cool the second of said thermally conductive element to a temperature indicative of ice formation on said first surface, characterised in that the surface area of said first surface is smaller than the second surface

The thermally conductive element comprises a first surface that is exposed to the environment and a second surface to which the heating and cooling effects are applied, wherein the surface area of said first surface is smaller than the second surface. One advantage of presenting the smaller area to be exposed to ice formation is that it reduces the (heat load) power requirement of the cooling element. Therefore the thermally conductive element may be cooled such that said first surface may be cooled to a temperature indicative of ice formation with less difficulty than if the areas of said first and second surfaces were the same.

Preferably, the means for cooling comprises a bi-directional heat pump. More preferably the bi-directional heat pump is a Peltier heat pump. Advantageously, the means for cooling further comprises a heat sink. The means for heating may be a separate heater or the Peltier heat pump, such that it provides both the heating and cooling functions.

Conventional heating and cooling means such as commercial off the shelf Peltier elements are unable to apply sufficient heating and particularly cooling power to meet the power requirements for said sensor under ordinary flight conditions without said thermally conducting element. Under restricted flight conditions conventional heating and cooling means may provide sufficient power to change the surface temperature of said sensor, but the power which must be used to drive said sensor is undesirably large, and the time taken for said sensor to heat or to cool is undesirably extended, thereby causing a delay in each measurement of the proximity to or degree of icing.

The thermally conductive element is selected from a material that permits good heat transfer, such that any heating or cooling of the second surface is directly transferred without significant time delay to the first surface and vice versa. Preferably the element is made from a metal or metalloid, more preferably a metal, particularly one which has a high thermal conductivity. Preferably the metal has a low heat capacity. Yet more preferably the metal has a low density, and particularly preferred metal is aluminium or an alloy thereof.

The thermally conductive element has a first surface which is smaller than the second surface, however, the overall three dimensional shape of said element may be any commonly selected three dimensional shape. The shape may be selected to fit into a specifically defined cavity, or to reduce mass etc. Therefore the side faces of the element i.e. those which join the first surface to the second surface may be any convenient shape and may be straight, stepped, curved, or undulating, such as for example trapezoidal or frustroconical configurations.

One particularly convenient configuration is one wherein the element has a substantially stepped configuration, this allows for a thermal seal to be created around the step portion, so as to thermally isolate the second surface of the element from any direct exposure to the outer environment i.e. such that substantially all of the heat flow occurs between the first and second surfaces via the thermally conductive element.

In a preferred arrangement the ratio of the area of the first:second surface is in the range of 1:1.4 to 1:25, more preferably in the range of 1:2 to 1:20, yet more preferably 1:4 to 1:16

Preferably, the ratio of the area of first surface:second surface may be adjusted to include an engineering tolerance, for example in device to device variation in efficiency of the heating/cooling module.

Preferably the ratio of areas of the first surface to the second surface is not diminished unnecessarily below that required to achieve proper temperature control under the required flight conditions. Unnecessary reduction in the area of the first surface will in general reduce the sensitivity, signal to noise ratio and accuracy of the ice detector.

Conveniently the shape and dimensions of the second surface of the thermally conductive element is substantially the same as that of the active surface of the Peltier element.

The temperature detector may be any means of measuring a temperature or a change in temperature, such as, for example a thermometer or thermocouple, preferably a thermocouple. The temperature measurements may be taken from the first surface, the second surface or even as an average temperature of the thermally conductive element, preferably the measurements are taken from the first surface. The temperature detector may be located internally or externally to first and/or second surfaces of the thermally conductive element. In a convenient arrangement the thermocouple may be located inside the thermally conductive element, such that the temperature sensitive tip of the thermocouple is located immediately behind the first surface, so as to provide a temperature measurement at the first surface. Locating the tip in this manner may reduce any affects of air flow induced cooling.

The heat load on each unit area of the said first surface may be estimated according to known principles by summing the different contributions to heat transfer at the surface. Major contributions to the heat load can arise from:
Convective heat transfer between the first surface and the air, dependant on the difference between the total air temperature including the kinetic energy of the air and the temperature of the first surface, and on the heat transfer coefficient at the first surface which may be estimated from the Nusselt number of the airflow.
The energy required to heat or cool the liquid water content of air to the temperature of the first surface. This depends on the liquid water content of the airstream, the airspeed, and the temperature difference between the first surface and the static temperature of the air.
The kinetic energy carried by the water droplets, which depends on the liquid water content of the air, and the airspeed.
The latent heat of fusion of the impinging water droplets, in the case that ice is forming on the first surface. This depends on the liquid water content of the air, and the airspeed.
The latent heat of the ice film accumulated on the first surface, in the case that the thermally conductive element via the second surface is being heated through a temperature interval including the melting point of ice. This depends on the liquid water content of the air, the airspeed and the period of time over which ice has accumulated on the first surface of the sensor.
Heat transferred through vapour transport of water between cloud water droplets and a film of ice or water on the first surface, which depends on the temperature difference between the airstream and the first surface of the sensor.

All of these modes of heat transfer and contributions to heat load provide a contribution to the total heat load which is essentially proportional to the area of the first surface.

By evaluating these quantities by standard methods, the heat load on said first surface may be evaluated under each set of flight conditions of concern, for example under the different flight conditions specified for continuous maximum icing in Appendix C of publication CS-25—Certification Specifications For Large Aeroplanes issued by the European Aviation Safety Agency. Corresponding estimates of the heat load may be made under conditions of intermittent maximum icing defined in the same document.

An estimate of the heat transfer capacity may also be made at the second surface of the element. Details of this estimate will depend on the means employed for heating and cooling of the thermally conductive element, but in general the heat pumping element will be less effective in cooling if a large temperature difference exists across it. Means for cooling the sensor will invariably have a thermal efficiency below 100%, depending on the working temperature gradient, and the resulting waste heat must be accounted for in estimating the available capacity for heat transfer. The thermal resistance of the heating/cooling element, of the thermally conductive element and of the interfaces must also be accounted for.

The maximum heat load on a given unit area of said first surface may be balanced against the heat pumping capacity applied at the second surface. The thermal capacity of the thermally conductive element, the effective heat capacity of the active surface of the means for heating and cooling which abuts said thermally conductive element, and of the rate at which said heating and cooling means is required to change the temperature of the thermally conductive element, must be factored into the calculations. The maximum heating or cooling power available in the system, minus the heat required to change the temperature of the conductive element gives the available heat pumping capacity.

In a preferred embodiment of the invention the second surface of the thermally heat conductive element has substantially the same area as the active surface of the means for heating or cooling. The ratio of areas of the first surface to the second surface is then set such that the available heat pumping capacity minus the heat load on the first surface is sufficient to change the sensor temperature at the required rate under the range of flight conditions where it is necessary to control the sensor to a temperature indicative of ice formation.

In one embodiment of the invention, the sensor device is configured to be embedded so that the first surface lies flush with a surface of a body. The surface may form part of a vehicle, vessel or aircraft. In a preferred embodiment the surface is part of an aircraft, such as an aircraft skin or wing. In an alternative embodiment the device is part of a structure mounted on an aircraft, such as a strut or a fin.

The device may be mounted or embedded such that the first surface lies substantially parallel to the direction of airflow over the aircraft. Alternatively, the device may be mounted or embedded so that the first surface is substantially perpendicular to the direction of airflow over the aircraft. It is an advantage that the device may be employed to determine icing conditions either in a laminar boundary layer region, or in a region of flow stagnation.

According to a third aspect of the present invention there is provided a system for measuring the rate of ice formation, the system comprising:

a thermally conductive element comprising a first and second surface, said first surface exposed to the environment; means for cooling or heating the second surface;
a temperature detector for providing a signal representative of the temperature of the first surface;
a power monitor for determining an amount power required to heat or cool the first surface to a temperature indicative of ice formation on said first surface; and processor means for determining, from the detected temperatures and the amount of heating or cooling power, a rate of ice formation of the environment to which the first surface is exposed, characterised in that the surface area of said first surface is smaller than the second surface.

The system may be used to measure the rate of ice formation during icing conditions. Furthermore, the system may be operated so as to measure the likelihood i.e. the proximate nature of icing conditions, which may be useful information in conditions which are known or are suspected to be typical ice forming environments.

According to a fifth aspect of the present invention there is provided a system for determining a proximity to icing conditions of an environment, the system comprising:

a thermally conductive element comprising a first and second surface, said first surface exposed to the environment;
means for cooling or heating the second surface;
a temperature detector for providing a signal representative of the temperature of the first surface;
a power monitor for determining an amount power required to heat or cool the first surface to a temperature indicative of ice formation on said first surface; and
processor means for determining, from the detected temperatures and the amount of heating or cooling power, the proximity to icing conditions of the environment to which the first surface is exposed, characterised in that the surface area of said first surface is smaller than the second surface.

According to a sixth aspect of the present invention there is provided a method of measuring the rate of ice formation in an icing environment, comprising the steps of:

i) providing a thermally conductive element comprising a first and second surface wherein the surface area of said first surface is smaller than the second surface,
ii) causing said first surface to be exposed to the environment;
iii) cooling or heating the second surface;
iv) monitoring the temperature of the first surface;
v) determining an amount of power required to heat or cool the second surface to a temperature to overcome the latent heat of ice formation on said first surface; and
v) determining, from the monitored temperatures and the amount of heating or cooling power, a rate of ice formation of the environment to which the first surface is exposed.

According to a seventh aspect of the present invention there is provided a method of determining a proximity to icing conditions of an environment, comprising the steps of:

i) providing a thermally conductive element comprising a first and second surface wherein the surface area of said first surface is smaller than the second surface,
ii) causing said first surface to be exposed to the environment;
iii) cooling or heating the second surface;
iv) monitoring the temperature of the first surface;
v) determining an amount of power required to heat or cool the second surface to a temperature indicative of ice formation on said first surface; and
vi) determining, from the monitored temperatures and the amount of heating or cooling power, a proximity to icing conditions of the environment to which the first surface is exposed.

Alternatively steps iv) and iv) of the sixth and seventh aspects may be replaced by

vi) determining the temperature difference between the first and second surfaces, calculating the heat flux through the thermally conductive element at a temperature indicative of ice formation on said first surface; and
vii) determining, from the monitored temperatures and the heat flux, a rate of ice formation or proximity to icing conditions of the environment to which the first surface is exposed.

In a preferred embodiment the proximity to icing conditions has a value defined as the difference between a first temperature and the temperature indicative of ice formation. The first temperature may be a prevailing air temperature. Alternatively, the first temperature may be the temperature of the surface at the start of the cooling or heating step.

Preferably, the methods of the fourth to seventh aspects further comprises the step of determining an icing potential by measuring the rate of change and direction of the proximity to icing conditions.

Alternatively, or additionally, the methods according to the invention may further comprise the step of determining a freezing fraction, wherein the freezing fraction is a dimensionless measure of the icing potential.

In one embodiment of the invention, the step of cooling or heating the second surface may be performed with a constant power. The temperature indicative of ice formation may be determined by measuring the variation of temperature with time and detecting a plateau or change in direction in the variation of temperature with time resulting from the latent heat of ice formation on said first surface.

In an alternative embodiment, the step of cooling or heating the second surface comprises controlling the cooling or heating to provide a constant rate of change of temperature per unit time. The temperature indicative of ice formation may be determined by monitoring the cooling or heating power with time to detect the temperature at which a change in the power occurs resulting from the latent heat of ice formation.

In embodiments of the invention, the method may comprise alternately cooling and heating the second surface. The proximity to icing conditions may be determined both when the second surface is heated and when it is cooled. The method may then be repeated continuously so as to monitor the proximity to icing conditions on said first surface.

In a preferred embodiment, the method further comprises the step of determining a severity of icing. Preferably the step of determining the severity of icing comprises measuring the magnitude of an increase in temperature or an increase in heat flow when ice formation occurs during cooling. The severity i.e. degree or extent of icing may be represented in different ways such as the rate of ice formation on the aircraft, the total thickness of ice accumulated, or the liquid water content of the air in grams per cubic metre.

It is an advantage that as well as being given information on the proximity to icing conditions, the pilot can be made aware of the severity of the conditions. The need to take averting action may be influenced by the severity of the conditions. Also, the effectiveness of any averting action taken will be reflected by a change in the severity.

According to a further aspect of the present invention there is provided a thermally conductive element suitable for use in an ice detector sensor comprising a thermoelectric detector means, said element comprising a first and second surface, wherein said first surface is exposed to the environment and said second surface is in thermal contact with said detector, characterised in that the surface area of said first surface is smaller than the second surface. Preferably the thermoelectric detector means is a Peltier element.

According to a further aspect of the present invention there is provided a passive sensor device for determining the rate of ice formation of an environment the device comprising:

a thermally conductive element comprising a first and second surface, said first surface exposed to the environment,
a Peltier element located in thermal contact with said second surface,
optionally a temperature detector for providing an indication of the temperature of the first surface;
whereby the rate of ice formation can be determined by measuring the voltage output of the Peltier element in response to the temperature differential across said Peltier element, characterised in that the surface area of said first surface is smaller than the second surface.

Embodiments of the invention will now be described by way of an example with reference to the drawings, in which:

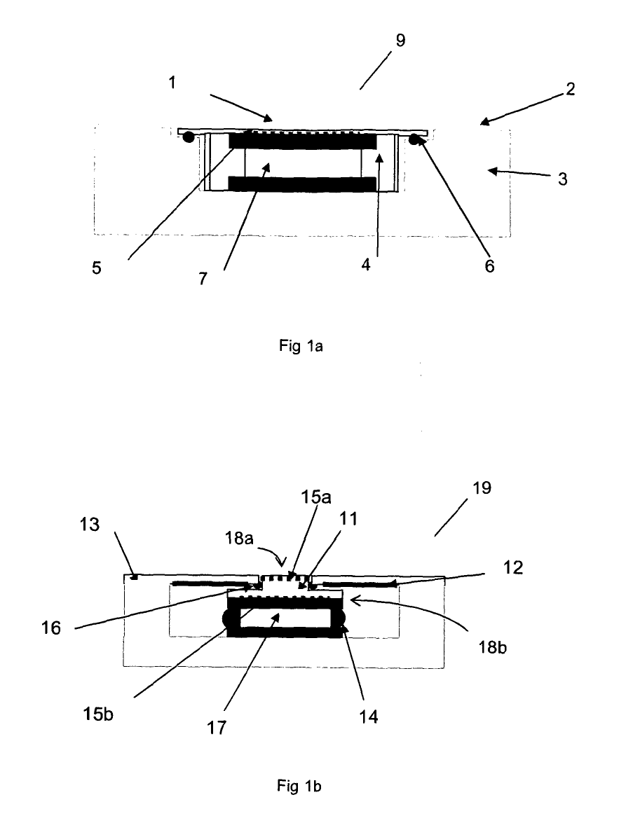

FIG. 1a, is a side view of a sensor device according to the prior art.

FIG. 1b is a side view of a sensor device according to the present invention;

FIG. 1c, is a side view of an alternative thermally conductive element for use in the present invention.

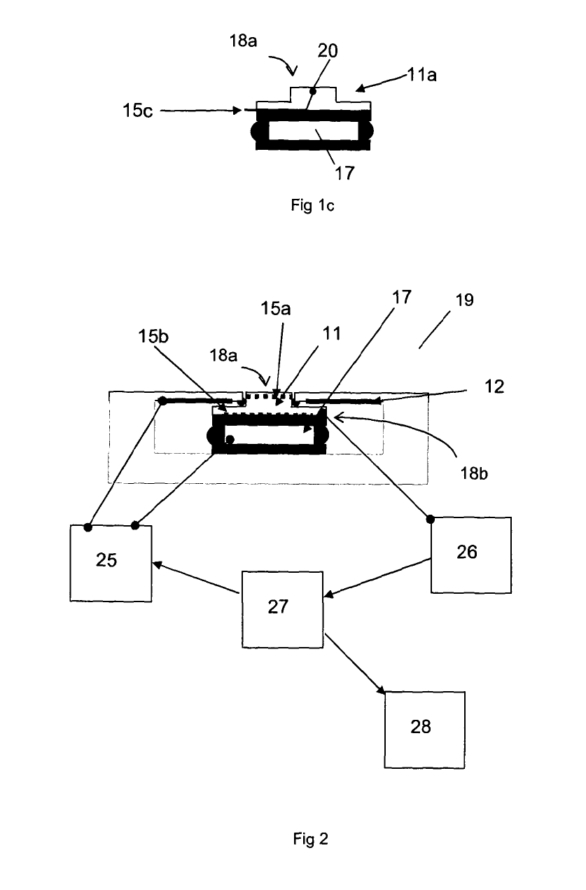

FIG. 2 is a diagram showing the interrelationship between the sensor device of FIG. 1a and other components of a system according to the present invention;

Referring to FIG. 1a is a prior art device, a sensor device 9 may typically located in a heat sink mounting 3, which may be located in the fuselage of an aircraft (not shown). The sensor device 9 comprises a surface 1 which is exposed to the surrounding environment. The surface 1 is thermally isolated from the fuselage 3, by a mounting and thermal isolation means 6. The sensor device 9 further comprises means 7 for cooling or heating the exposed surface 1. The heating and cooling means 7 is preferably a bidirectional heat pump, for example a Peltier heat pump, and is electronically controlled by a controller (not shown). The bidirectional heat pump 7 may be potted into an encapsulant 4. A platinum resistance thermometer 5, situated behind the surface 1 outputs temperature readings indicative of the temperature of the surface 1 to an acquisition system (not shown). Optionally, a plurality of thermometers may be employed, providing a plurality of temperature readings, which may be averaged by the acquisition system.

Referring to FIG. 1b, shows a device according to the invention comprising a sensor device 19 typically located in a heat sink mounting 13, and which may be located in the fuselage of an aircraft (not shown). The sensor 19 comprises a thermally conductive element 11, with a first surface 18a which is exposed to the surrounding environment and may be located flush to the fuselage of an aircraft (not shown). The element 11 and hence first surface 18a are thermally isolated from the fuselage 13, by a mounting and thermal isolation means 16. The sensor device 19 further comprises means 17 for cooling the second surface 18b. This cooling means 17 is preferably a bidirectional heat pump, such as for example a Peltier heat pump, and may be electronically controlled by a controller (not shown). The bidirectional heat pump 17 may be potted into an encapsulant 14 to provide stability and rigidity to the system. A heating means 12 is provided to heat the element 11, in particular via the second surface 18b. A thermocouple 15a, is situated proximate to the first surface 18a, which outputs temperature readings that are indicative of the temperature of the first surface 18a to an acquisition system (not shown). Optionally a further thermocouple 15b may be situated behind the second surface 18b to provide temperature readings of the second surface. Optionally, a plurality of thermocouples may be employed, providing a plurality of temperature readings, which may be averaged by the acquisition system.

FIG. 1c shows an alternative to the thermally conductive element 11, as disclosed in FIG. 1b, in the form of element 11a and is shown mounted onto a Peltier device 17. In this arrangement the thermocouple 15c is located inside the thermally conductive element 11a, such that the temperature sensitive tip 20 of the thermocouple 15c is located immediately behind the first surface 18a, so as to provide a temperature measurement at the first surface. Locating the tip 20 inside the element 11a may reduce any affects of air flow induced cooling. The element 11a, may therefore be used as a direct replacement of element 11 as in FIG. 1b.

FIG. 2 shows a system for measuring the rate of ice formation and determining proximity to icing conditions; said system comprises a sensor device 19 as shown in more detail in FIG. 1b. A controller 25 is provided to electronically control the Peltier element 17 to cool the second surface 18b. The controller 25 additionally controls the heat provided, via heating means 12, to the second surface 18b. The temperature readings from the thermocouple 15a (and optionally 15b) are outputted to an acquisition system 26. A processing device 27 is provided to process the temperature readings from the acquisition system 26, and the results are outputted to a visual or audio indicator 28, which may be observed by the pilot.

In use, the controller 25 electronically controls the Peltier element 17 to cool and heating means 12 to heat the second surface 18b. The thermocouple 15a monitors a temperature that is indicative of the first surface 18a and the temperature readings are provided to the acquisition system 26. The processor 27 processes the temperature readings from the acquisition system 26 in a manner that will be described in more detail below, and provides the indicator 28 with information indicative of the likelihood of ice formation or the rate of ice formation. The processor 27 then instructs the controller 25 to heat or cool the second surface 18b as appropriate, to allow the measurement of the likelihood of ice formation or the rate of ice formation, on the first surface 18a to be repeated.

When the air temperature is above that at which ice forms on the an airframe surface, the sensor device 19 is operable to predict either how near the current flight conditions (“prevailing air conditions”) are to the conditions in which ice is likely to form on the first surface 18a (“surface icing conditions”). The controller 25 instructs the Peltier element 17 to cool down the second surface 18b. If the water content of the surrounding atmosphere is sufficiently high, ice will eventually form on the cooled first surface 18a. The difference between the prevailing air temperature and the temperature at which ice will form on the first surface 18a is a measure of the proximity to icing conditions. Alternatively the quantity of heat removed that causes icing to occur (i.e. the amount of cooling required to form ice), provides a quantitative measure of how near the prevailing air conditions are to surface icing conditions, i.e. the “proximity to icing conditions”. When the air temperature is indicative of ice formation the sensor device 19 is operable to measure the rate of ice formation.

After ice has accumulated on the first surface 18a, and a measurement made of the proximity to icing conditions, the controller 25 controls the heating means 12 to heat the second surface 18b up again. When the temperature of the first surface 18a reaches the desired value, e.g. the previous temperature of the surface before cooling and subsequent heating, or the ambient air temperature, the cooling process is started again and the process of determining icing proximity as described above is repeated. This enables the system to continually monitor and update the proximity to icing conditions.

When icing conditions exist the prevailing environmental conditions are such that ice will form on the first surface 18a either with minimal or no cooling by the Peltier element 17). In these conditions, the controller 25 controls the heating means 12 to heat the surface 18b and the amount of heating required to melt the ice that has formed on the first surface 18a gives a measure of the amount of ice that has formed. This information can be useful to the pilot who can take action to bring the aircraft out of the icing conditions. The element 11a, in FIG. 1c, may be used in place of element 11, with the thermocouple 15c, providing the measurement of temperature at the first surface 18a.

In addition, an “icing potential” may be calculated. This is defined as the rate of change, and direction, of the icing proximity, and it provides an indication of the severity of the icing conditions.

Further, a “freezing fraction”, which is a dimensionless quantity indicating the icing potential, is defined by scaling the measured icing potential. If the freezing fraction has a value of zero, this indicates that no ice will form and there is no risk of icing in the near future and in the prevailing conditions. A freezing fraction of unity indicates that ice is forming already. A value between zero and one gives a measure of the icing potential.

A measure may also be made of the “icing severity”, which is defined as the magnitude of the temperature rise (due to the release of latent heat) during cooling.

1. A sensor device for use in a system for determining the rate of ice formation of an environment the device comprising:
a thermally conductive element according to claim 20;
a heater/cooler, connectable to a power source, for cooling or heating the second surface of the thermally conductive element; and
a temperature detector for providing a signal representative of the temperature of the first surface of the thermally conductive element;
whereby the rate of ice formation can be determined from the temperature signals and power required to heat or cool the second of said thermally conductive element to a temperature indicative of ice formation on said first surface.

2. A sensor device according to claim 1, wherein the rate of ice formation provides a measure to the proximity to icing conditions of the environment.

3. A sensor according to claim 1, wherein the sensor device is configured to be embedded so that the first surface lies flush with a surface.

4. A sensor according to claim 1, wherein the device is part of a structure mounted on an aircraft, vehicle or vessel.

5. A sensor according to claim 1, wherein the element has substantially vertical sides to provide a substantially stepped configuration.

6. A sensor according to claim 1, wherein the element is trapezoidal or frustroconical in nature.

7. A sensor according to claim 1 wherein the ratio of the area of the first surface:second surface is in the range of 1:1.4 to 1:25.

8. A sensor according to claim 7, wherein the ratio is the range of 1:4 to 1:16.

9. A sensor according to claim 1, wherein the element is a metal or metalloid.

10. A sensor according to claim 9 wherein the metal is aluminium or alloy thereof.

11. A sensor according to claim 1 wherein the temperature detector is a thermocouple located within said element.

12. A sensor according to claim 1 wherein the heater/cooler comprises a Peltier element for cooling.

13. A sensor according to claim 1 wherein the heater/cooler is a Peltier element.

14. A system for measuring the rate of ice formation, the system comprising:
a thermally conductive element according to claim 20;
a heater/cooler for cooling or heating the second surface of the thermally conductive element;
a temperature detector for providing a signal representative of the temperature of the first surface of the thermally conductive element;
a power monitor for determining an amount power required to heat or cool the first surface to a temperature indicative of ice formation on said first surface; and
a processor for determining, from the detected temperatures and the amount of heating or cooling power, a rate of ice formation of the environment to which the first surface is exposed.

15. A system according to claim 14 wherein the rate of ice formation provides a measure of a proximity to icing conditions of the environment.

16. A method of measuring the rate of ice formation in an icing environment, comprising the steps of:
i) providing a thermally conductive element comprising a first and second surface wherein the surface area of said first surface is smaller than the second surface,
ii) causing said first surface to be exposed to the environment;
iii) cooling or heating the second surface;
iv) monitoring the temperature of the first surface;
v) determining an amount of power required to heat or cool the second surface to a temperature to overcome the latent heat of ice formation on said first surface; and
vi) determining, from the monitored temperatures and the amount of heating or cooling power, a rate of ice formation of the environment to which the first surface is exposed.

17. A method of measuring the rate of ice formation in an icing environment, comprising the steps of:
i) providing a thermally conductive element comprising a first and second surface wherein the surface area of said first surface is smaller than the second surface,
ii) causing said first surface to be exposed to the environment;
iii) cooling or heating the second surface;
iv) monitoring the temperature of the first surface;
v) determining the temperature difference between the first and second surfaces, calculating the heat flux through the thermally conductive element at a temperature to overcome the latent heat of ice formation on said first surface; and
vi) determining, from the monitored temperatures and the heat flux, a rate of ice formation of the environment to which the first surface is exposed.

18. A method of determining a proximity to icing conditions of an environment, comprising the steps of:
i) providing a thermally conductive element comprising a first and second surface wherein the surface area of said first surface is smaller than the second surface,
ii) causing said first surface to be exposed to the environment;
iii) cooling or heating the second surface;
iv) monitoring the temperature of the first surface;
v) determining an amount of power required to heat or cool the second surface to a temperature indicative of ice formation on said first surface; and
vi) determining, from the monitored temperatures and the amount of heating or cooling power, a proximity to icing conditions of the environment to which the first surface is exposed.

19. A method of determining a proximity to icing conditions of an environment, comprising the steps of:
i) providing a thermally conductive element comprising a first and second surface wherein the surface area of said first surface is smaller than the second surface,
ii) causing said first surface to be exposed to the environment;
iii) cooling or heating the second surface;
iv) monitoring the temperature of the first surface;
v) determining the temperature difference between the first and second surfaces, calculating the heat flux through the thermally conductive element at a temperature indicative of ice formation on said first surface; and
vi) determining, from the monitored temperatures and the heat flux, a proximity to icing conditions of the environment to which the first surface is exposed.

20. A thermally conductive element suitable for use in an ice detector sensor comprising a thermoelectric detector, said element comprising a first and second surface, wherein said first surface is exposed to the environment and said second surface is in thermal contact with said thermoelectric detector, wherein the surface area of said first surface is smaller than the second surface.

21. An element according to claim 20 wherein the thermoelectric detector is a Peltier element.

22. A passive sensor device for determining the rate of ice formation of an environment the device comprising:
a thermally conductive element according to claim 20,
a Peltier element located in thermal contact with said second surface,
optionally a temperature detector for providing an indication of the temperature of the first surface;
whereby the rate of ice formation can be determined by measuring the voltage output of the Peltier element in response to the temperature differential across said Peltier element.

23. (canceled)
